(19) United States
(12) Patent Application Publication
(10) Pub. No.: US 2011/0318521 A1
(43) Pub. Date: Dec. 29, 2011

(54) DISPOSABLE NECKBAND FOR ANIMAL IDENTIFICATION

(75) Inventor: Bryan M. Waltersdorf, Oconomowoc, WI (US)

(73) Assignee: WRISTBAND RESOURCES, INC., Brookfield, WI (US)

(21) Appl. No.: 12/823,252

(22) Filed: Jun. 25, 2010

(51) Int. Cl. G09F 3/00

(52) U.S. Cl. 428/43

(57) ABSTRACT

A neckband assembly comprising a neckband strap including a weakened zone across the width, and an adhesive positioned on the strap. In one embodiment, the strap comprises at least two weakened zones across the width, and the weakened zones are spaced from each other by a distance that is between 5% and 50% of the length of the strap. The weakened zone(s) can be in the form of a perforation line having a series of linearly-spaced holds separated by spaces. The above-described neckband assembly can be provided in the form of a sheet of such assemblies, wherein the corresponding straps are separated from each other by tear-away zones extending parallel to the length of the straps. Preferably, the tear-away zones are weaker than the weakened zones. Similar to the weakened zones, the tear-away zones can comprise perforation lines having a series of linearly-spaced holds separated by spaces.

### BACKGROUND

The present invention generally relates to disposable neckbands that are commonly used for animal identification upon entry into an animal hospital, veterinary clinic, or similar facility.

Disposable wristbands are commonly used as a means for identifying an individual. For example, wristbands can be used to identify individuals that are authorized to be in a certain location (e.g., at a concert or a park) or to consume certain food or beverages (e.g., at a party), such as alcoholic beverages. Wristbands are commonly of a certain color or imprinted pattern to facilitate visual identification at a distance. These wristbands are commonly made from Tyvek, molded plastic, or any other suitable material.

Similar bands are used to identify animals by wrapping the bands around the animal's neck. Because of the vast difference in animal neck sizes (e.g., between a cat and a horse), these “neckbands” commonly come in a variety of lengths. However, even with the availability of different lengths, it is still often necessary to trim the band to the desired length after the band has been wrapped around the animal's neck.

### SUMMARY OF THE INVENTION

The above-described neckbands are commonly made of a very durable and strong material that can withstand a large force without tearing. One potential problem with such a neckband is that it can get caught on an object and choke the animal. In addition, the toughness of the neckband material makes it difficult to tear by hand in order to reduce the length of the neckband, and a scissors or other tool is typically required to cut the neckband to the desired length.

The present invention provides a neckband assembly comprising a neckband strap (e.g., made from spun plastic material) having a length and a width smaller than the length, and an adhesive positioned on the strap. The strap includes a weakened zone across the width to facilitate tearing of the strap in the event it gets caught on something, and to facilitate manual tearing of the strap in order to reduce the length of the strap without scissors. Preferably, the strap has a length that is at least twelve times, preferably at least fifteen times, and preferably about twenty times the width.

In one embodiment, the strap comprises at least two weakened zones (preferably three or four or more) across the width. In this embodiment, the weakened zones are spaced from each other by a distance that is between 5% and 50% (preferably between 7% and 25%, and more preferably about 12.5%) of the length of the strap.

The weakened zone(s) can be in the form of a perforation line, such as one having a series of linearly-spaced holds separated by spaces. When the strap is made of a 0.007 inch thick spun plastic material (e.g., Tyvek), the length of the holds can be between 0.02 inches and 0.03 inches and the length of the spaces can be between 0.05 inches and 0.20 inches. In this regard, it is noted that the lengths of the holds in the weakened zone can be about 10%-30% (preferably 15%-25%, and most preferably about 20%) of the lengths of the spaces. In addition, the cross-sectional area of the strap can be reduced 25%-90% (preferably 50%-87%, and most preferably about 83%) in the weakened zone (i.e., length of spaces compared to total width of strap).

The above-described neckband assembly can be provided in the form of a sheet of such assemblies, wherein the corresponding straps are separated from each other by tear-away zones extending parallel to the length of the straps. Preferably, the tear-away zones are weaker than the weakened zones. Similar to the weakened zones, the tear-away zones preferably comprise a perforation line, such as one having a series of linearly-spaced holds separated by spaces. When the strap is made of a 0.007 inch thick spun plastic material (e.g., Tyvek), the length of the holds can be between 0.005 inches and 0.02 inches and the length of the spaces can be between 0.20 inches and 0.50 inches. In this regard, it is noted that the lengths of the holds in the tear-away zone can be about 1%-10% (preferably 3% to 7%, and most preferably about 5%) of the lengths of the spaces. In addition, the cross-sectional area of the strap can be reduced about 92%-98% (preferably 94-97%, and most preferably about 95%) in the tear-away zone (i.e., length of spaces compared to total length of strap).

### BRIEF DESCRIPTION OF THE DRAWINGS

FIG. 1 is a plan view of a sheet of neckbands embodying the present invention.

FIG. 2 is a portion of the view of FIG. 1 enlarged for magnification purposes.

FIG. 3 is a perspective view of a single neckband from FIG. 1.

FIG. 4 illustrates the neckband of FIG. 3 wrapped around the neck of an animal.

### DETAILED DESCRIPTION

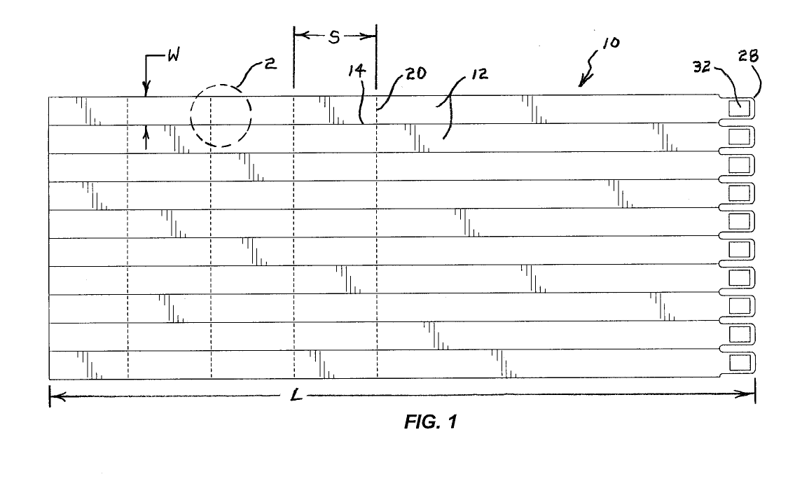

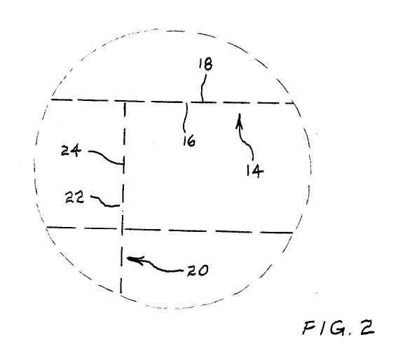

FIGS. 1-2 illustrates a sheet 10 of neckbands having ten neckband straps 12 coupled in a side-by-side relationship. The sheet 10 is made of a spun plastic material, such as 0.007 inch thick TYVEK spunbonded olefin (TYVEK is a trademark of E.I. DuPont). Each strap is about twenty inches long L and about one inch wide W. It should be understood that other materials could be used for the sheet, such as molded or extruded plastic, paper, or anything other suitable material.

The straps 12 are separated from each other by a series of parallel tear-away zones in the form of first perforation lines 14 extending the length L of the sheet. The first perforation lines 14 are designed to be easily torn by a user when separating a strap 12 from the sheet. In the illustrated embodiment, each first perforation line 14 comprises a series of linearly-spaced first holds 16 separated by first spaces 18 (FIG. 2—not to scale). The first holds 16 have a length (i.e., parallel to the first perforation line 14) of about 0.015 inches each, and the first spaces 18 have a length of about 0.31 inches each. Thus, in the illustrated embodiment, the length of the first holds 16 is about 4.8% of the length of the first spaces 18, and the first spaces account for about 95% of the overall length L of the strap 12.

A series of four weakened zones in the form of second perforation lines 20 are provided across the width W of the straps 12. The second perforation lines 20 are designed to be stronger than the first perforation line 14, and specifically so that the second perforation lines 20 do not tear when the straps 12 are being separated from the sheet 10. In the illustrated embodiment, the second perforation lines 20 comprise a series of linearly-spaced second holds 22 separated by second spaces 24 (FIG. 2—not to scale). The second holds 22 have a length (i.e., parallel to the second perforation line 20) of about 0.025 inches each, and the second spaces 24 have a length of about 0.125 inches each. Thus, in the illustrated embodiment, the length of the second holds 22 is about 20% of the length of the second spaces 24, and the second spaces 24 account for about 83% of the overall width W of the strap 12.

As used herein, a perforation line is intended to mean any series of perforations that facilitate tearing of the material, and should not be construed as being limited to a series of perforations in a straight line. That is, the perforations would be in a curved, zig-sag, or any other appropriate shape. In addition, it should be appreciated that other means for creating the weakened zones and tear-away zones could be utilized. For example, instead of perforation lines, the zones could be created by scoring or by utilizing a different, weaker material in the zones.

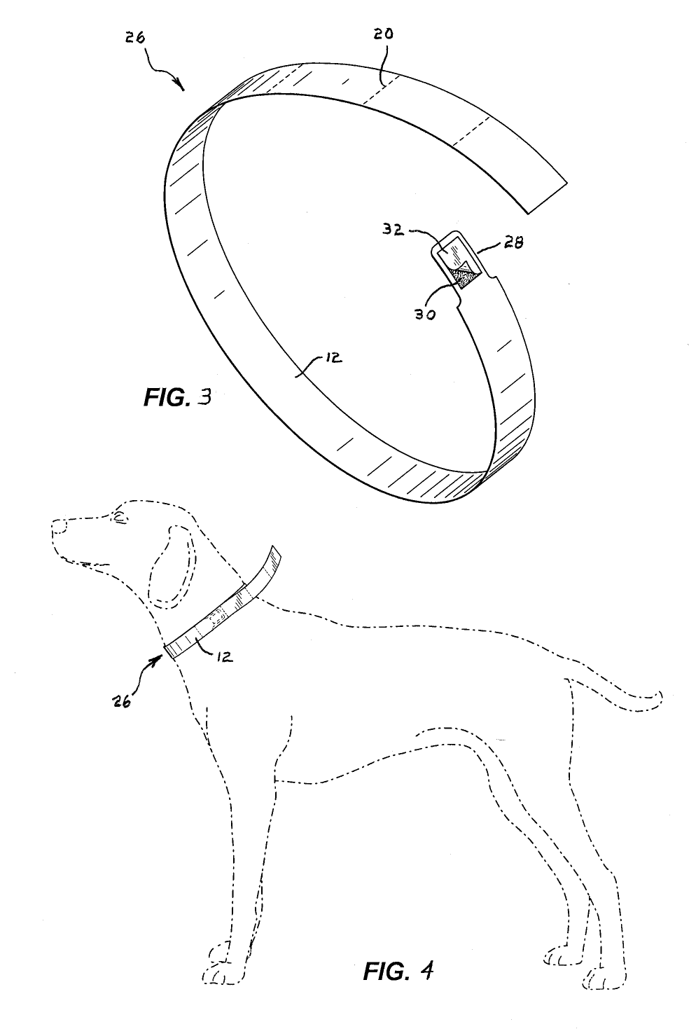

The second perforation lines 20 provide the function of tearing when the force on the strap 12 exceeds a desired level. For example, if the strap 12 is formed into a loop 26 around an animal's neck (FIGS. 3-4), at least one of the second perforation lines 20 will break if the loop 26 becomes snagged on an object to create a force beyond what the second perforation lines 20 can handle. The second perforation lines 20 are spaced from each other by a sufficient spacing S that facilitates the positioning of at least one of the second perforation lines 20 in a location that will be subjected to the force when the strap 12 becomes snagged on an object.

The second perforation lines 20 also facilitate shortening the length of the strap 12 to accommodate animals having different sized necks. More specifically, the illustrated straps 12 can be manually torn along the second perforation lines 20 to achieve the desired length of the straps 12. In the illustrated embodiment, the position of the second perforation lines 20 allows adjustment of the length of the strap 12 from twenty inches to ten inches in two-and-a-half inch increments. Thus, the spacing S of the second perforation lines 20 is about 12.5% of the overall length L of the straps. It should be understood that other numbers of second perforation lines 20 and spacings S can be used.

The end of each strap 12 includes a narrow portion 28 having an adhesive patch 30 that facilitates securing the strap 12 into a loop 26 around an object, such as an animal neck for identification. A removable tab 32 is positioned over the adhesive patch 30 to prevent the adhesive from sticking to anything prior to use. Prior to forming into a loop 26, the tab 32 is peeled away to expose the adhesive patch 30, as is generally known in the art.

1. A sheet of neckbands comprising:
a plurality of neckband straps, each having a length and a width smaller than the length, wherein the straps are separated from each other by a tear-away zone, and wherein each strap includes a weakened zone across the width; and
an adhesive positioned on each strap.

2. A sheet of neckbands as claimed in claim 1, wherein the tear-away zone is weaker than the weakened zone.

3. A sheet of neckbands as claimed in claim 1, wherein the strap comprises at least two weakened zones across the width.

4. A sheet of neckbands as claimed in claim 3, wherein the weakened zones are spaced from each other by a distance that is between 5% and 50% of the length of the strap

5. A sheet of neckbands as claimed in claim 1, wherein the strap comprises at least three weakened zones across the width.

6. A sheet of neckbands as claimed in claim 1, wherein the strap comprises at least four weakened zones across the width.

7. A sheet of neckbands as claimed in claim 1, wherein the tear-away zone comprises a perforation line.

8. A sheet of neckbands as claimed in claim 7, wherein the perforation line comprises a series of linearly-spaced holds separated by spaces, wherein the length of the holds is between 0.005 inches and 0.02 inches and the length of the spaces is between 0.20 inches and 0.50 inches.

9. A sheet of neckbands as claimed in claim 1, wherein the weakened zone comprises a perforation line.

10. A sheet of neckbands as claimed in claim 9, wherein the perforation line comprises a series of linearly-spaced holds separated by spaces, wherein the length of the holds is between 0.02 inches and 0.03 inches and the length of the spaces is between 0.05 inches and 0.20 inches.

11. A neckband assembly comprising:
a neckband strap having a length and a width smaller than the length, wherein the strap includes a weakened zone across the width; and
an adhesive positioned on the strap.

12. A neckband assembly as claimed in claim 11, wherein the length is at least twelve times the width.

13. A neckband assembly as claimed in claim 11, wherein the strap comprises at least two weakened zones across the width.

14. A neckband assembly as claimed in claim 13, wherein the weakened zones are spaced from each other by a distance that is between 5% and 50% of the length of the strap

15. A neckband assembly as claimed in claim 11, wherein the strap comprises at least three weakened zones across the width.

16. A neckband assembly as claimed in claim 11, wherein the strap comprises at least four weakened zones across the width.

17. A neckband assembly as claimed in claim 11, wherein the strap comprises a spun plastic material.

18. A neckband assembly as claimed in claim 11, wherein the weakened zone comprises a perforation line.

19. A neckband assembly as claimed in claim 18, wherein the perforation line comprises a series of linearly-spaced holds separated by spaces, wherein the length of the holds is between 0.02 inches and 0.03 inches and the length of the spaces is between 0.05 inches and 0.20 inches.
